(19) United States
(12) Patent Application Publication
(10) Pub. No.: US 2021/0252473 A1
(43) Pub. Date: Aug. 19, 2021

(54) ACTIVE CARBON MOLDED BODY

(71) Applicant: LIXIL Corporation, Tokyo (JP)

(72) Inventors: Kazuhiro SATO, Tokyo (JP); Masanari TOYAMA, Tokyo (JP); Hirohito NAKAJIMA, Tokyo (JP); Takeyuki YAMAMOTO, Tokyo (JP); Takahisa ISHIKAWA, Tokyo (JP); Hiroki MAENAMI, Tokyo (JP); Hajime OTA, Tokyo (JP); Takao OTSUKA, Tokyo (JP); Daiki HONDA, Tokyo (JP); Hiroto TASAKI, Tokyo (JP)

(21) Appl. No.: 16/972,648

(22) PCT Filed: Apr. 1, 2019
(86) PCT No.: PCT/JP2019/014497

§ 371 Date: Dec. 7, 2020

(30) Foreign Application Priority Data
Jun. 8, 2018 (JP) 2018-110660

(51) Int. Cl. B01J 20/20; C02F 1/28; B01J 20/28; C01B 32/354

(52) U.S. Cl. CPC B01J 20/20; C02F 1/283; B01J 20/28085; C01P 2004/03; B01J 20/28011; B01J 20/2803; B01J 20/28004; C01B 32/354

(57) ABSTRACT

An active carbon molded body that comprises a plurality of active carbon granules that are foiled from aggregates of active carbon particles. The active carbon granules include a fibrous granulation binder. A plurality of communicating holes are foamed in the active carbon molded body. A pore size distribution curve obtained for the active carbon molded body by a mercury intrusion has: a first peak that is from first pores that are famed between active carbon particles; and a second peak that is from second pores that are foamed between active carbon particles and is for a smaller pore size than the first peak.

The present invention thereby provides an active carbon molded body that has high water purification capacity and has a filtration flow rate that is at least a prescribed value.

This application is based on and claims the benefit of priority from Japanese Patent Application No. 2018-110660, filed on 8 Jun. 2018, the content of which is incorporated herein by reference.

### TECHNICAL FIELD

The present invention relates to an active carbon molded body. More specifically, the present invention relates to an active carbon molded body for water purification.

### BACKGROUND ART

Conventionally, tap water purified with a water purifier is used as drinking water and water for cooking.

In general, a water purifier incorporates a filter and the like, together with active carbon or a molded body of active carbon particles as a filter medium.
For example, a water purifier has been proposed which incorporates a molded body of active carbon particles such as powder of coconut shell active carbon.

A reduction in the particle diameter of the active carbon particles leads to an increase in a contact area between the active carbon particles and water flowing through the water purifier, whereby the purification performance is improved. On the other hand, such a reduction causes a decrease in a filtration flow rate per unit time decreases, resulting in inconvenience to the user.

The purification performance and the filtration flow rate have a trade-off relationship. In order to maintain a filtration flow rate of about 2.5 L/min, which does not cause inconvenience to the user, and to increase the purification capability, the average particle diameter of the active carbon is adjusted to about 80 μm (see Patent Documents 1 to 3).
Patent Document 1: Japanese Unexamined Patent Application, Publication No. 2015-73919
Patent Document 2: Japanese Unexamined Patent Application, Publication No. 2016-59826
Patent Document 3: PCT International Publication No. WO2011/016548

### DISCLOSURE OF THE INVENTION

### Problems to be Solved by the Invention

Meanwhile, to facilitate handling of active carbon, use of active carbon granules has been under consideration.

Even when such active carbon granules are used, it is required to increase the water purification capability while maintaining a filtration flow rate which does not cause inconvenience to the user.

In view of the foregoing, it is an object of the present invention to provide an active carbon molded body having a filtration flow rate not less than a predetermined value and having a high water purification capability.

### Means for Solving the Problems

A first aspect of the present invention is directed to an active carbon molded body comprising a plurality of active carbon granules each comprising an aggregation of active carbon particles. The active carbon granule includes a granulation-purpose fibrous binder. The active carbon molded body has a plurality of communicating pores formed therein. The active carbon molded body exhibits a pore diameter distribution curve determined by a mercury intrusion, the pore diameter distribution curve having a first peak derived from first pores formed among the plurality of active carbon granules and a second peak derived from second pores formed among the active carbon particles, the second peak corresponding to smaller pore diameters than the first peak.

A second aspect of the present invention is an embodiment of the first aspect, wherein a pore diameter ratio of the second pores to the first pores is preferably 0.1 to 0.36.

A third aspect of the present invention is an embodiment of the second aspect, wherein the pore diameter ratio of the second pores to the first pores is preferably 0.16 to 0.28.

A fourth aspect of the present invention is an embodiment of the first to third aspects, wherein a volume ratio of the second pores to the first pores is preferably 0.33 to 0.91.

A fifth aspect of the present invention is an embodiment of the first to fourth aspects. The active carbon molded body of the fifth aspect preferably has a density of 0.25 g/cc to 0.35 g/cc.

### Effects of the Invention

The present invention can provide an active carbon molded body having a filtration flow rate not less than a predetermined value and having a high water purification capability.

### BRIEF DESCRIPTION OF THE DRAWINGS

FIG. 1 is a schematic diagram showing, on an enlarged scale, a cross section of the vicinity of a surface of a conventional active carbon particle;

FIG. 2 is a schematic diagram showing, on an enlarged scale, a cross section of the vicinity of a surface of an active carbon particle according to the present embodiment;

FIG. 3 is a schematic diagram showing flowing water that passes through communicating pores in active carbon granules according to the present embodiment;

FIG. 4 is an SEM photograph of a conventional active carbon particle;

FIG. 5 is an SEM photograph of an active carbon particle according to the present embodiment;

FIG. 6 is an SEM photograph of an active carbon particle according to the present embodiment;

FIG. 7 is a graph showing a pore distribution curve of a molded body of conventional active carbon particles, determined by a laser diffraction method; and

FIG. 8 is a graph showing pore distribution of a molded body of active carbon granules according to the present embodiment, determined by a laser diffraction method.

### PREFERRED MODE FOR CARRYING OUT THE INVENTION

An embodiment of the present invention will be described below. Note that the present invention is not limited to the following embodiment.

Active carbon granules according to the present embodiment are usable in, for example, a water purification cartridge incorporated in a water purification apparatus for purifying water to be treated, such as tap water.

The active carbon granules of this type remove removal targets contained in water to be treated, by oxidative decomposition or adsorption.

Examples of the removal targets include odor substances in tap water, such as free residual chlorine, and organic compounds in tap water, such as trihalomethane.

<Active Carbon Granule>

The active carbon granule according to the present embodiment includes active carbon particles and a granulation-purpose fibrous binder. The active carbon particles form an aggregation while having the granulation-purpose fibrous binder interposed among them. The active carbon granule has therein communicating pores.

As the active carbon particles, active carbon produced from any starting material can be used.

Specifically, usable active carbon can be produced by way of activating carbon obtained from carbonizing coconut shell, coal, phenolic resin, or the like at a high temperature. Activation is a reaction which changes a carbonaceous raw material into a porous material by developing micropores of the carbonaceous raw material, and is caused by, for example, a gas such as carbon dioxide or water vapor, or by a chemical. The majority of such active carbon particles comprising carbon, whereas there are some active carbon particles comprising a compound of carbon and oxygen or a compound of carbon and hydrogen.

The active carbon particles according to the present embodiment preferably have a median particle diameter D₁ of 40 μm or less.

When the median particle diameter of the active carbon particles is within this range, the active carbon granules including the active carbon particles increase in adsorption amount of the removal targets per unit mass.

This is because the specific surface area of the active carbon granule including the active carbon particles increases with a decrease in the median particle diameter of the active carbon particles.

Note that the median particle diameter D₁ of the active carbon particles may be greater than 40 μm, but in this case, the necessity to granulate the active carbon is low because the active carbon particles are less prone to densification and the resistance to water flow is less likely to increase. Further, as will be described later, from the viewpoint of an adsorption rate of the removal targets, it is preferable that the median particle diameter of the active carbon particles is small.

In the present embodiment, the median particle diameter D₁ of the active carbon particles is a value measured by a laser diffraction method, and refers to the value of a 50% diameter (D₅₀) in volume-based cumulative fraction.

For example, D₁ is measured by Microtrac MT3300EXII (a laser diffraction/scattering-type particle diameter distribution measurement device, manufactured by MicrotracBEL Corp.). A pore distribution curve of the active carbon molded body was determined by way of measurement of pore diameter distribution based on a mercury intrusion (measurement pressure: 8.6 kPa to 200 MPa), using a “Poremaster 33P” manufactured by Quantachrome Instruments.

The active carbon granules including the above-described active carbon particles according to the present embodiment have a high adsorption rate with respect to the removal targets.

Water purification cartridges included in water purifiers are required to have extremely high adsorption rates.

For example, a common water purification cartridge has a capacity of about 35 cc. If tap water as water to be treated flowing at a flow rate of, for example, 2500 cc/min is made to permeate the common water purification cartridge, it is calculated that all the water in the cartridge is replaced in about 0.8 seconds.

Therefore, when the active carbon has an insufficient adsorption rate, the removal targets cannot be removed to a sufficient extent, depending on the flow rate of the water to be treated.

The relationship between the adsorption rate and the particle diameter of active carbon will be described with reference to the accompanying drawings.

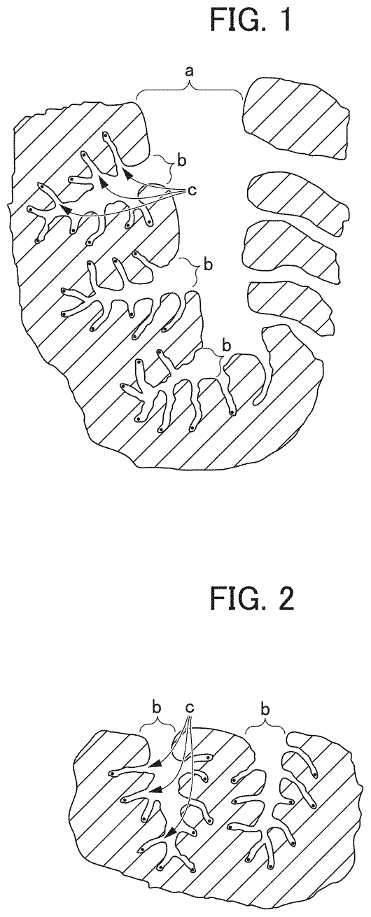

FIG. 1 is a schematic diagram showing, on an enlarged scale, a cross section of the vicinity of a surface of an active carbon particle (having a particle diameter of 80 μm) used in a conventional water purifier.

FIG. 2 is a schematic diagram also showing, on an enlarged scale, a cross section of the vicinity of a surface of an active carbon particle of the present embodiment having a relatively small diameter (e.g., a particle diameter of about 10 μm).

In FIGS. 1 and 2, the reference character a denotes a macropore having a diameter of 50 nm or greater, the reference character b denotes a mesopore having a diameter of 2 nm to 50 nm, and the reference character c denotes a micropore having a diameter of 2 nm or less.

Portions with a black dot are reaction sites where the removal targets are adsorbed.

Each pore in the surface of active carbon adsorbs a substance that matches with the size of the pore. As shown in FIGS. 1 and 2, the majority of the reaction sites are present in the micropores c.

This is because water treatment principally removes, as the removal targets, substances having a relatively small molecular weight, such as free chlorine and CHCl₃ as trihalomethane.

In FIG. 1, the removal targets, such as CHCl₃, which have entered through the surface of active carbon, pass through the macropores a, the mesopores b, and the micropores c, and then, arrive at the reaction sites.

In contrast, in FIG. 2, the removal targets, such as CHCl₃, which have entered through the surface, pass through the mesopores b and the micropores c, and then, arrive at the reaction sites. Thus, the distance to the reaction sites in FIG. 2 is shorter than in FIG. 1.

Consequently, the active carbon particles according to the present embodiment have a higher adsorption rate than the conventional active carbon particles.

In addition, the active carbon granule has therein a plurality of communicating pores.

The communicating pores are formed by way of connections between voids, i.e., small pores among the active carbon particles that form the active carbon granule.

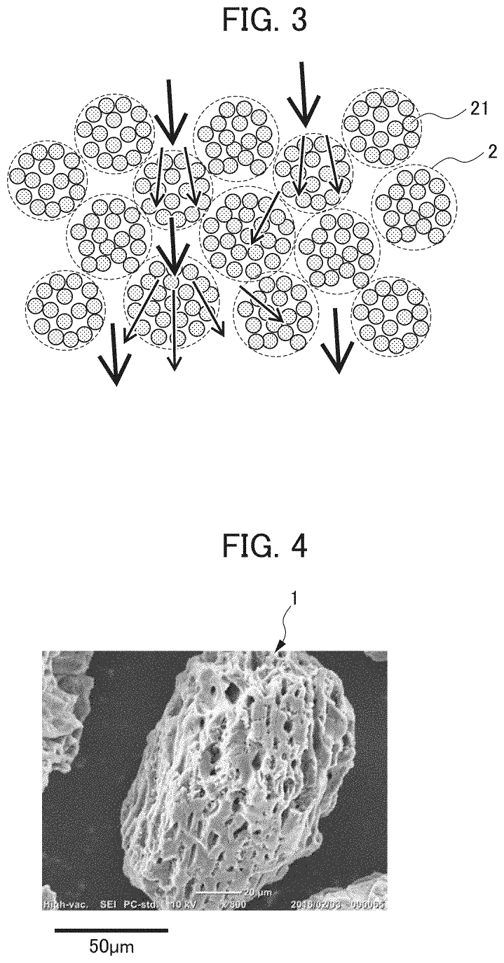

Since flowing water can pass through not only voids, i.e., large pores among the active carbon granules, but also the communicating pores constituted by the small pores, the active carbon granules have a lower resistance to water flow than active carbon particles having an equivalent size (see FIG. 3).

With this feature, the active carbon granules can increase the purification capability without reducing the filtration flow rate when used in a water purifier.

The fibrous binder included in the active carbon granule according to the present embodiment is fine fibers which are called, for example, microfibers or nanofibers, and are entangled with the active carbon particles so as to contribute to formation of the granulated body.

Examples of such microfibers and nanofibers include cellulose microfibers and cellulose nanofibers.

Cellulose is known to be produced from trees, plants, some animals, fungi, and the like.

Fibers with a structure in which cellulose forms a fibrous aggregation and having a fiber diameter of micro size are called cellulose microfibers. Such fibers having a fiber diameter smaller than micro size are called cellulose nanofibers.

In nature, cellulose nanofibers exist in a firmly aggregated state due to interactions such as hydrogen bonds between the fibers, while a cellulose nanofiber as a single fiber hardly exists.

For example, pulp used as a raw material for paper is obtained by defibrating wood, and has a fiber diameter of micro size ranging from about 10 μm to about 80 μm. Pulp has a fibrous form in which cellulose nanofibers are firmly aggregated by interactions such as the hydrogen bonds described above. By further defibrating the pulp, cellulose nanofibers can be obtained.

Examples of the defibration method include chemical processing such as an acid hydrolysis method and mechanical processing such as a grinder method.

The active carbon granule according to the present embodiment is comprising the above-described active carbon particles and the cellulose nanofibers or the like as the above-described fibers, which bind to each other. Although a mechanism is uncertain by which the active carbon particles and the cellulose nanofibers or the like as the fibrous binder bind to each other to form the granulated body, the following reason is conceivable, for example.

First, the fibrous binder and the active carbon particles become entangled with one another, whereby mechanical strength is provided.

The active carbon granules according to the present embodiment are produced as granulated bodies having the fibrous binder and the active carbon particles entangled with one another, by a method of producing the active carbon granules to be described later.

Further, the surface of active carbon particles is not completely hydrophobic, and several percent of oxygen is present on the surface of active carbon in the form of a carboxy group or a hydroxy group.

Similarly, on the surface of cellulose nanofibers or the like, a hydroxy group deriving from cellulose is present. Therefore, it is presumed that hydrogen bonds exist between the surface of active carbon and the cellulose nanofibers, whereby the firm granulated body is formed.

Note that the “bond” and “bind” as used in the description of the present invention refer to a concept including the mechanical bond due to entanglement of the above-described fibrous binder and the active carbon particles and the chemical bond such as the hydrogen bond.

<Water Purification Cartridge>

The water purification cartridge according to the present embodiment is for use in a water purifier for purifying water to be treated, such as tap water, and includes the active carbon granules described above.

The water purification cartridge according to the present embodiment is not particularly limited.

The active carbon granules to be included in the water purification cartridge are, for example, dispersed in water and converted into a slurry, and then, subjected to suction molding so as to be used as the active carbon molded body. The active carbon molded body may further include fibril fibers or an ion-exchange material.

The water purification cartridge according to the present embodiment may further include a ceramic filter or the like as a support for supporting the active carbon molded body, a filter such as a hollow fiber membrane, or a nonwoven fabric or the like for protecting the surface of the active carbon molded body.

<Method of Producing Active Carbon Granules>

A method of producing the active carbon granules according to the present embodiment includes a stirring step, a granulation step, and a dehydration step.

First, in the stirring step, active carbon particles pulverized and classified by a known method and having an arbitrary particle diameter, a fibrous binder such as nanofibers, and water are mixed together and stirred, thereby obtaining a slurry-like raw material mixture.

Next, in the granulation step, the raw material mixture is granulated.

Although any granulation process may be used, the granulation can be performed using a spray dryer method, for example. According to the spray dryer method, the raw material mixture is loaded into a spray dryer and spray dried, whereby granules of the raw material mixture are obtained.

The granules can be made to have a desired size by appropriately adjusting parameters, such as an ejection pressure of the spray dryer, a nozzle diameter, a circulating air volume, and a temperature.

Using the spray dryer method makes it possible to produce the granulated bodies (in a dry state) including the active carbon particles and the fibrous binder that are entangled with one another.

Thereafter, in the dehydration step, the formed granules of the raw material mixture are placed in a heating furnace and dehydrated.

The heating temperature is not particularly limited, and may be set to, for example, about 130° C.

The dehydration in the dehydration step firms up the granulated bodies of the active carbon particles and the fibrous binder, such that the structure of the granulated bodies does not collapse even when the granulated bodies are placed into water.

Further, the granulated bodies have therein communicating pores formed among the active carbon particles and allowing flowing water to pass therethrough.

Through the steps described above, the active carbon granules according to the present embodiment can be produced.

The active carbon granules according to the present embodiment preferably have a median particle diameter D₂ greater than 40 μm although the median particle diameter D₂ is not particularly limited.

The active carbon granules having a median particle diameter D₂ greater than 40 μm are less prone to densification, thereby making it less likely for the resistance to water flow to increase.

The median particle diameter D₂ is preferably 2 mm or less. Adjusting the median particle diameter D₂ to 2 mm or less can cause the active carbon granules to have smaller voids among them, and can increase the entire active carbon in the adsorption amount per volume.

From this viewpoint, it is more preferable to adjust the median particle diameter D₂ to 150 μm or less.

Like the median particle diameter D₁, the median particle diameter D₂ is a value measured by the laser diffraction method, and refers to the value of a 50% diameter (D₅₀) in volume-based cumulative fraction.

The above-described active carbon granules according to the present embodiment are superior in purification performance to the conventional active carbon particles.

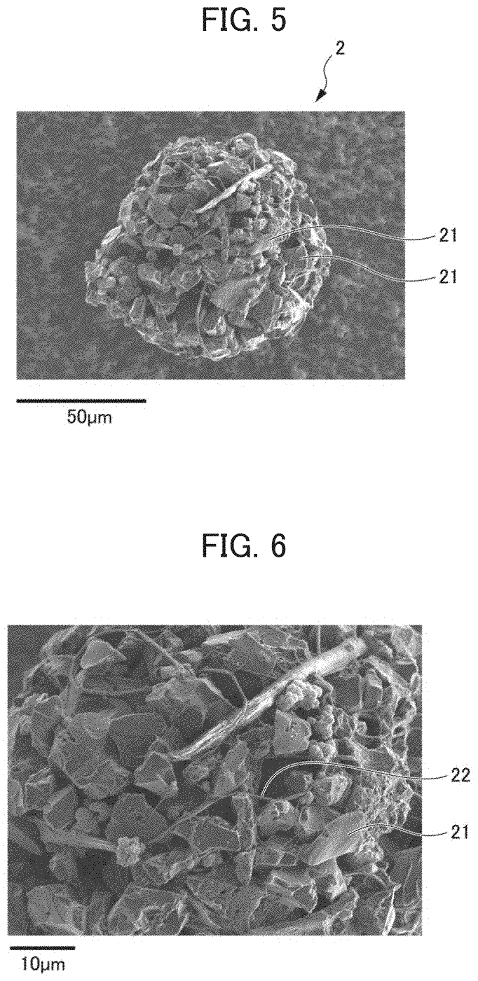

FIG. 4 is a photograph of a conventional active carbon particle. FIG. 5 is a photograph of the active carbon granule according to the present embodiment. Both photographs were taken by a scanning electron microscope after the particles and the granules had been sifted through a sieve of 63 μm/90 μm (170 mesh/230 mesh) so as to have a similar particle size distribution.

FIG. 4 shows the conventional active carbon particle 1, whereas FIG. 5 shows the active carbon granule 2 according to the present embodiment that includes the active carbon particles 21.

FIG. 6 is a photograph of the active carbon granule 2 according to the present embodiment, taken on a further enlarged scale by a scanning electron microscope.

As is apparent from FIG. 6, the active carbon particles 21 and the fibers 22, which are entangled with one another, form the granulated body, without a binder resin.

As is apparent from FIGS. 4 and 5, the active carbon granule 2 according to the present embodiment is formed by granulating the active carbon particles 21 that have a smaller particle diameter than the conventional active carbon particle 1, and is superior in specific surface area.

In the present embodiment, any method of determining the presence or absence of the granulated body may be used. For example, the presence or absence of granulated body can be determined by observation using an electron microscope or the like.

<Active Carbon Molded Body>

A molded body having a desired shape is obtained by subjecting the above-described active carbon granules to suction-compression.

The active carbon molded body has therein not only active carbon granule-communicating pores that are formed among the plurality of active carbon particles included in each active carbon granule, but also active carbon molded body-communicating pores formed by connections of the active carbon granule-communicating pores and voids among the plurality of active carbon granules.

The active carbon molded body exhibits a pore diameter distribution curve determined by a mercury intrusion, the pore diameter distribution curve having a first peak derived from pores (first pores) formed among the plurality of active carbon granules and a second peak derived from pores (second pores) in the active carbon granules, the second peak corresponding to smaller pore diameters than the first peak.

The active carbon molded body has a density preferably from 0.25 g/cc to 0.35 g/cc, and more preferably of 0.30 g/cc. The active carbon molded body having a density within this range can achieve high purification performance while maintaining a predetermined filtration flow rate.

The above-described active carbon molded body according to the present embodiment exerts the following effects.

(1) The active carbon molded body is formed by the active carbon granules including the active carbon particles and the fibrous binder. The active carbon molded body exhibits a pore diameter distribution curve determined by a laser diffraction method, the pore diameter distribution curve having a first peak derived from first pores formed among the plurality of active carbon granules and a second peak derived from the second pores formed in the active carbon granules, the second peak corresponding to smaller pore diameters than the first peak.

This feature enables granulation of the active carbon particles without using a resin as a binder component. Further, since the active carbon particles have the communicating pores allowing flowing water to pass therethrough, the resistance to water flow is reduced. Thus, the active carbon molded body can be provided which can achieve a satisfactory filtration flow rate and high purification performance.

(2) In the active carbon molded body described in (1), a pore diameter ratio of the second pores to the first pores is set to be 0.1 to 0.36.

With this feature, a preferable value of the pore diameter ratio is specified for the active carbon molded body, thereby improving the purification performance.

(3) In the active carbon molded body described in (2), the pore diameter ratio of the second pores to the first pores is set to be 0.16 to 0.28.

This feature contributes to further improvement of the purification performance.

(4) In the active carbon molded body described in (1) to (3), a volume ratio of the second pores to the first pores is set to be 0.33 to 0.91.

With this feature, a preferable volume ratio is specified for the active carbon molded body, thereby further improving the purification performance.

(5) The active carbon molded body described in (1) to (4) has a density of 0.25 g/cc to 0.35 g/cc.

With this feature, a preferable density range is specified for the active carbon molded body, thereby further improving the purification performance.

Note that the present invention is not limited to the embodiment described above, but encompasses modifications and improvements within the range in which the object of the present invention can be achieved.

Although cellulose nanofibers and the like have been described as examples of the fibrous binder of the present invention, the fibrous binder is not limited to the cellulose nanofibers and the like, and may be any binder as long as granulated bodies can be formed using it.

### EXAMPLES

The present invention will be described further in detail with reference to examples. Note that the present invention is not limited to the following examples.

### Examples 1 to 5, Comparative Example 1

Active carbon granules according to Examples 1 to 5 were produced by the following methods.

First, active carbon was pulverized and classified so that active carbon particles were produced.

Cellulose nanofibers having an average fiber diameter φ_{F} of 0.03 μm and water were added to the active carbon particles. The particles and the nanofibers were dispersed by way of stirring, whereby a slurry-like mixture was obtained. The slurry-like mixture was processed using a spray drier, and thereafter, dehydrated by being heated at about 130° C. in a heating furnace. As a result, granulated bodies were obtained. The obtained granulated bodies were classified using a 170/325 mesh sieve, whereby active carbon granules were obtained. As Comparative Example 1, conventional active carbon particles were used, without producing active carbon granules.

The active carbon granules of Examples 1 to 5 and the conventional active carbon particles of Comparative Example 1 were each formed into a molded article having a density at which a value of 2.5 L/min was achieved under equivalent water pressure. The obtained molded articles were each subjected to a chlorine filtering capability test and a turbidity filtering capability test, based on JIS 53201.

The results are shown in Table 1.

In addition, the pore distribution of the conventional product and that of the molded bodies of the present invention were measured.

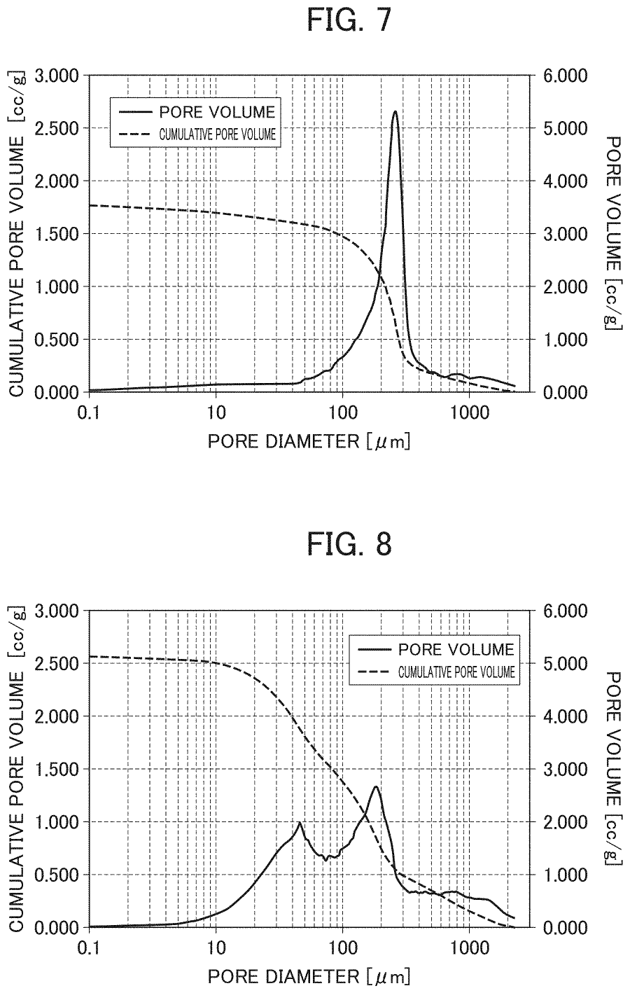

The results are shown in FIGS. 7 and 8.

The above active carbon granules were molded into a cylindrical shape having an outer diameter of 24.7 mm, an inner diameter of 8.3 mm, and a height of 90 mm.

TABLE 1

| | | Comparative | | | | | |
|---|---|---|---|---|---|---|---|
| | | Example 1 | Example 1 | Example 2 | Example 3 | Example 4 | Example 5 |
| Bulk Density | g/cc | 0.38 | 0.28 | 0.27 | 0.27 | 0.28 | 0.28 |
| of Molded Body | | | | | | | |
| Active Carbon | μm | — | 65.0 | 70.0 | 69.0 | 75.0 | 76.0 |
| Granule Diameter | | | | | | | |
| Active Carbon | μm | 74.0 | 4.2 | 7.0 | 10.0 | 14.7 | 20.6 |
| Particle Diameter | | | | | | | |
| First Pore | μm | 25.9 | 19.1 | 20.3 | 18.7 | 22.3 | 22.1 |
| | Volume cc/g | 5.4 | 3.9 | 3.5 | 2.7 | 2.4 | 2.2 |
| Second Pore | μm | — | 1.9 | 3.3 | 4.6 | 6.3 | 7.9 |
| | Volume cc/g | — | 1.3 | 1.6 | 2.0 | 1.9 | 2.0 |
| Second Pore/ | Pore Diameter Ratio | — | 0.10 | 0.16 | 0.25 | 0.28 | 0.36 |
| First Pore | Volume Ratio | — | 0.33 | 0.46 | 0.74 | 0.79 | 0.91 |
| Chlorine | L | 1400 | 2200 | 2300 | 2500 | 2300 | 2200 |
| Filtering | | | | | | | |
| Capability | | | | | | | |
| Turbidity | L | 1500 | 2850 | 2350 | 2450 | 3900 | 3900 |
| Filtering | | | | | | | |
| Capability | | | | | | | |

Under the conditions in which a filtration flow rate of 2.5 L/min is achieved under equivalent water pressure, Examples 1 to 5 exhibited significantly improved chlorine filtering capability, in comparison with Comparative Example 1.

An increase in the specific surface area due to the use of the active carbon granules is presumed to have enabled the active carbon to adsorb residual chlorine with enhanced efficiency. In addition, the communicating pores allowing flowing water to pass therethrough are presumed to have reduced the resistance to water flow and to have ensured the filtration flow rate.

Regarding the density of the molded bodies, while Comparative Example 1 as the conventional product had a density of 0.38 g/cc, the active carbon granules of Examples 1 to 5 had a smaller density of 0.27 g/cc to 0.28 g/cc. This is because Examples 1 to 5 have the second pores formed therein, and are provided with more voids among carbon, in comparison with Comparative Example 1.

Due to pores in the active carbon granules, Examples 1 to 5 have a larger specific surface area than Comparative Example 1. As a result, the purification performance of Examples 1 to 5 was significantly improved.

Here, although the value of the density of the molded body is not necessarily in simple correlation with the specific surface area, in view of Example 1 in which the active carbon granules were formed, it is estimated that Examples 1 to 5 have a larger specific surface area than Comparative Example 1, and have a low density in a certain correlation with increase in the specific surface area.

Thus, the active carbon molded bodies have a large specific surface area in the density range from 0.25 g/cc to 0.35 g/cc, and can achieve high purification performance.

The active carbon granules preferably have a granule diameter of 65.0 μm to 76.0 μm. Within this range, the first pores and the second pores are formed satisfactorily, thereby enabling high purification performance to be achieved.

The active carbon particles preferably have a particle diameter of 4.2 μm to 20.6 μm. Within this range, the above-described active carbon granules can be formed.

FIGS. 7 and 8 are graphs showing the pore distribution among the particles in the molded bodies of Comparative Example 1 and Example 3.

A comparison of the pore distribution among the particles between FIG. 7 and FIG. 8 shows that while FIG. 7 shows a high peak at one point, FIG. 8 shows two peaks, i.e., a higher peak and a lower peak at two separate points.

The peak in FIG. 7 indicates that the pore diameters of the pores among the active carbon particles are distributed in the vicinity of one value, whereas FIG. 8 shows a characteristic distribution having two distribution ranges, one of which corresponds to the pore diameters of the first pores among the active carbon granules and the other of which corresponds to the pore diameters of the second pores in the active carbon granules.

In the molded body, the pore diameter ratio of the second pores to the first pores is preferably 0.1 to 0.36, and more preferably 0.16 to 0.28.

In addition, it is preferable that the volume ratio of the second pores to the first pores is 0.33 to 0.91.

In this range, an active carbon molded body can be obtained which exhibits high purification performance due to the communicating pores.

### EXPLANATION OF REFERENCE NUMERALS

1: Active Carbon Particle
2: Active Carbon Granule
21: Active Carbon Particle
22: Fibrous Binder

1. An active carbon molded body comprising:
a plurality of active carbon granules each comprising an aggregation of active carbon particles
and a plurality of communicating pores in the active carbon molded body,
wherein the active carbon granule includes a fibrous binder,
the active carbon molded body exhibiting a pore diameter distribution curve determined by a mercury intrusion, the pore diameter distribution curve having a first peak derived from first pores formed among the plurality of active carbon granules and a second peak derived from second pores formed among the active carbon particles and the second pores are smaller than the first pores.

2. The active carbon molded body according to claim 1, wherein
a pore diameter ratio of the second pores to the first pores is 0.1 to 0.36.

3. The active carbon molded body according to claim 2, wherein
the pore diameter ratio of the second pores to the first pores is 0.16 to 0.28.

4. The active carbon molded body according to claim 1, wherein
a volume ratio of the second pores to the first pores is 0.33 to 0.91.

5. The active carbon molded body according to claim 1, having a density of 0.25 g/cc to 0.35 g/cc.

6. The active carbon molded body according to claim 2, wherein
a volume ratio of the second pores to the first pores is 0.33 to 0.91.

7. The active carbon molded body according to claim 3, wherein
a volume ratio of the second pores to the first pores is 0.33 to 0.91.

8. The active carbon molded body according to claim 2, wherein a density of the active carbon molded body is 0.25 g/cc to 0.35 g/cc.

9. The active carbon molded body according to claim 3, wherein a density of the active carbon molded body is 0.25 g/cc to 0.35 g/cc.

10. The active carbon molded body according to claim 4, wherein a density of the active carbon molded body is 0.25 g/cc to 0.35 g/cc.

11. The active carbon molded body according to claim 1, wherein the fibrous binder has a fiber diameter from 10 μm to 80 μm.

12. The active carbon molded body according to claim 1, wherein the active carbon particles has a median particle diameter D₁ of 40 μm or less.

13. The active carbon molded body according to claim 1, wherein the active carbon granules has a median particle diameter greater than 40 μm.

14. The active carbon molded body according to claim 1, wherein the active carbon granules has a median particle diameter greater is 2 mm or less.

15. The active carbon molded body according to claim 1, wherein the active carbon granules has a median particle diameter greater is 150 μm or less.

16. The active carbon molded body according to claim 1, wherein the active carbon granules have a granule diameter of 65.0 μm to 76.0 μm.

17. The active carbon molded body according to claim 1, wherein the active carbon particles have a particle diameter of 4.2 μm to 20.6 μm.

18. A water purification cartridge, comprising the active carbon molded body according to claim 1.
